(19) United States
(12) Patent Application Publication
(10) Pub. No.: US 2011/0130308 A1
(43) Pub. Date: Jun. 2, 2011

(54) MULTIPLEXED MICROARRAY AND METHOD OF FABRICATING THEREOF

(76) Inventors: John A. Luckey, Madison, WI (US); Emile Nuwaysir, Madison, WI (US)

(21) Appl. No.: 12/958,039

(22) Filed: Dec. 1, 2010

Related U.S. Application Data
(60) Provisional application No. 61/265,914, filed on Dec. 2, 2009.

(51) Int. Cl. C40B 40/08; C40B 50/18

(52) U.S. Cl. 506/17; 506/32

(57) ABSTRACT

A multiplexed array and method for fabricating a multiplexed array are disclosed. The multiplexed array includes a hydrophobic barrier formed on a substrate. The hydrophobic barrier includes a plurality of wells in which microarrays are located. A liquid cover slip is positioned to seal each of the wells.

### CROSS-REFERENCE TO RELATED U.S. PATENT APPLICATION

The present application claims priority under 35 U.S.C. §119(e) to U.S. Provisional Patent Application Ser. No. 61/265,914, entitled “Multiplexed microarray and Method of Fabricating Thereof,” which was filed on Dec. 2, 2009, the entirety of which is hereby incorporated by reference.

### TECHNICAL FIELD

The present disclosure relates, generally, to microarrays and, more particularly, to multiplexed microarrays for performing multiple assays and other tests or experiments.

### BACKGROUND

Deoxyribonucleic acid (DNA) microarray technology is used in many research areas such as gene expression and discovery, mutation detection, allelic and evolutionary sequence comparison, genome mapping, and the like. Microarrays allow researchers to perform a large number of concurrent experiments using, for example, multiple probes and a single test sample. In such microarrays, the microarray area is surrounded by a barrier such that the test sample may be placed in contact with the microarray but restricted from flowing out of the defined microarray area. In some microarrays, the top of the barrier is open to the environment, which can result in adverse evaporation of the test sample, contamination, and/or cross-mixing.

Multiplexed arrays are formed from multiple microarrays positioned on a single substrate. In a multiplexed array, a barrier may be used to surround each individual microarray such that a plurality of samples may be used with a single multiplexed array. The barrier retains the sample within the desired sub-array while restricting the sample from flowing or otherwise contacting adjacent or nearby sub-arrays of the multiplexed array. Again, some barriers of multiplexed arrays are open to the surrounding environment resulting in the potential undesirable evaporation of the test sample during the hybridization.

### SUMMARY

According to one aspect, a multiplexed array includes a substrate, a hydrophobic barrier, and a liquid cover slip. The substrate may be embodied as a glass substrate, a silicon substrate, or other suitable material. The hydrophobic barrier may be formed on the substrate. Additionally, the hydrophobic barrier may define a plurality of wells. Each well of the plurality of wells may include an opening for access to the interior of the well. A microarray may be positioned in each well and attached to the substrate. The liquid cover slip may be positioned in contact with the hydrophobic barrier and over the opening of each well to pneumatically seal the plurality of wells.

In some embodiments, the hydrophobic barrier may be formed from trityl-T amidite. Additionally, in some embodiments, the hydrophobic barrier may define at least twenty-four wells, at least ninety-six wells, or more wells. The microarray may be embodied as a deoxyribonucleic acid (DNA) microarray. in some embodiments.

Additionally, in some embodiments, the liquid cover slip may be embodied as a mineral oil cover slip. Additionally, the liquid cover slip may be embodied as a plurality of liquid cover slips in some embodiments. In such embodiments, each one of the plurality of liquid cover slips may be positioned over at least one opening of the plurality of wells. Additionally or alternatively, the liquid cover slip may be embodied as a quantity of liquid positioned in a container. In such embodiments, a portion of the hydrophobic barrier is positioned in the liquid. Further, in some embodiments, the multiplexed array may include a container in which liquid cover slip is positioned in the container.

According to another aspect, a multiplexed array apparatus may include a hydrophobic barrier formed on a substrate and a well-forming cover positioned over the hydrophobic barrier. The hydrophobic barrier and substrate may cooperate to define a plurality of wells. Each well may include an opening defined in an upper surface of the hydrophobic barrier and a microarray positioned therein.

The well-forming cover may be positioned a distance above the hydrophobic barrier and may define a plurality of openings to the corresponding plurality of wells. The well-forming cover in cooperation with the hydrophobic barrier may position and laterally confine a liquid sample in each of the plurality of wells when the sample is deposited therein. Additionally, the well-forming cover and the hydrophobic barrier may cooperate to confine and position a means for sealing the plurality of wells, which may be positioned over the well-forming cover. Such means of sealing the wells may be embodied as a liquid cover slip in some embodiments. However, in other embodiments the means for sealing the wells may be embodied as a physical cover such as a sealing foil/film or air-tight cover. For example, a sealing film may be attached to the upper surface of the well-forming cover after the liquid sample has been deposited into the well(s). Alternatively, a physical cover may be applied for the purpose of maintaining a humidity equilibrium that limits or otherwise prevents evaporation of the liquid sample during hybridization. In such embodiments, the physical cover may be embodied as a cover of various design and formed from various materials capable of forming a pneumatic seal with the well-forming cover.

In some embodiments, the hydrophobic barrier may be formed from trityl-T amidite. Additionally, in some embodiments, the hydrophobic barrier may define at least twenty-four wells, at least ninety-six wells, or more wells. The microarray may be embodied as a deoxyribonucleic acid (DNA) microarray. in some embodiments.

Additionally, in some embodiments, the liquid cover slip may be embodied as a mineral oil cover slip. Additionally, the liquid cover slip may be embodied as a plurality of liquid cover slips in some embodiments. In such embodiments, each one of the plurality of liquid cover slips may be positioned over at least one opening of the plurality of wells. Additionally or alternatively, the liquid cover slip may be embodied as a quantity of liquid positioned in a container. In such embodiments, a portion of the hydrophobic barrier is positioned in the liquid. Further, in some embodiments, the multiplexed array may include a container in which liquid cover slip is positioned in the container.

According to a further aspect, a method for fabricating a multiplexed array may include synthesizing a plurality of probes on a common substrate to form a plurality of microarrays. The method may also include forming a hydrophobic barrier on the common substrate. The hydrophobic barrier may be formed so as to surround each microarray to form a plurality of wells. The method may also include laterally confining the liquid sample via use of a liquid cover slip and/or a well-forming device. For example, in some embodiments, positioning the liquid cover slip may include inserting at least a portion of the hydrophobic barrier into a bath of mineral oil. Alternatively, the method may use an evaporative barrier (e.g., sealing film or physical cover) in place of the liquid cover slip to limit or otherwise prevent evaporation of the sample during hybridization.

### DESCRIPTION OF THE DRAWINGS

FIG. 1 is an elevational view of one embodiment of a multiplexed array;

FIG. 2 is another elevational view of the multiplexed array of FIG. 1;

FIG. 3 is a top plan view of the multiplexed array of FIG. 1;

FIG. 4 is a top plan view of one embodiment of a 96-plex array from a plurality of the multiplexed arrays of FIG. 1

FIG. 5 is a cross-sectional elevational view of the multiplexed array of FIG. 1;

FIG. 6 is a cross-sectional elevational view of another embodiment of a multiplexed array;

FIG. 7 is a cross-sectional elevational view of another embodiment of a multiplexed array;

FIG. 8 is a cross-sectional side view of another embodiment of a multiplexed array; and

FIG. 9 a method of fabricating the multiplexed array of FIGS. 1, 6, 7, and/or 8.

### DETAILED DESCRIPTION

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Some embodiments of the disclosure, or portions thereof, may be implemented in hardware, firmware, software, or any combination thereof. Embodiments of the disclosure may also be implemented as instructions stored on a tangible, machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; and others.

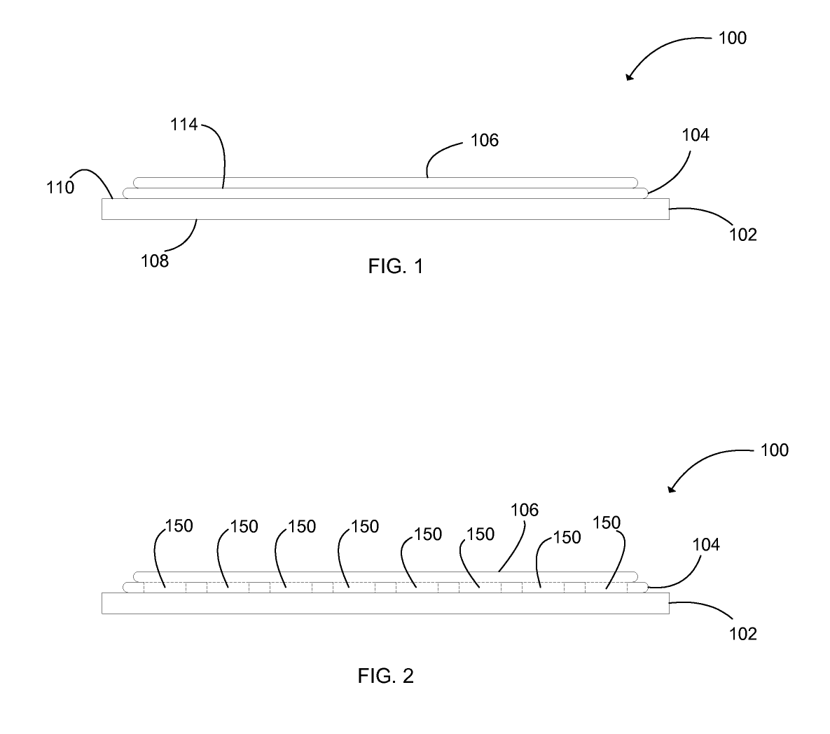

Referring to FIG. 1, in one embodiment, a multiplexed array 100 includes a substrate 102, a hydrophobic barrier 104 formed on the substrate 102, and a liquid cover slip 106 deposited or otherwise positioned on the hydrophobic barrier 104. The substrate 102 may be formed from any solid material suitable for supporting a microarray thereon. For example, the substrate 102 may be embodied as a glass substrate or a silicon substrate in some embodiments. The substrate 102 includes a lower surface 108 and an upper surface 110.

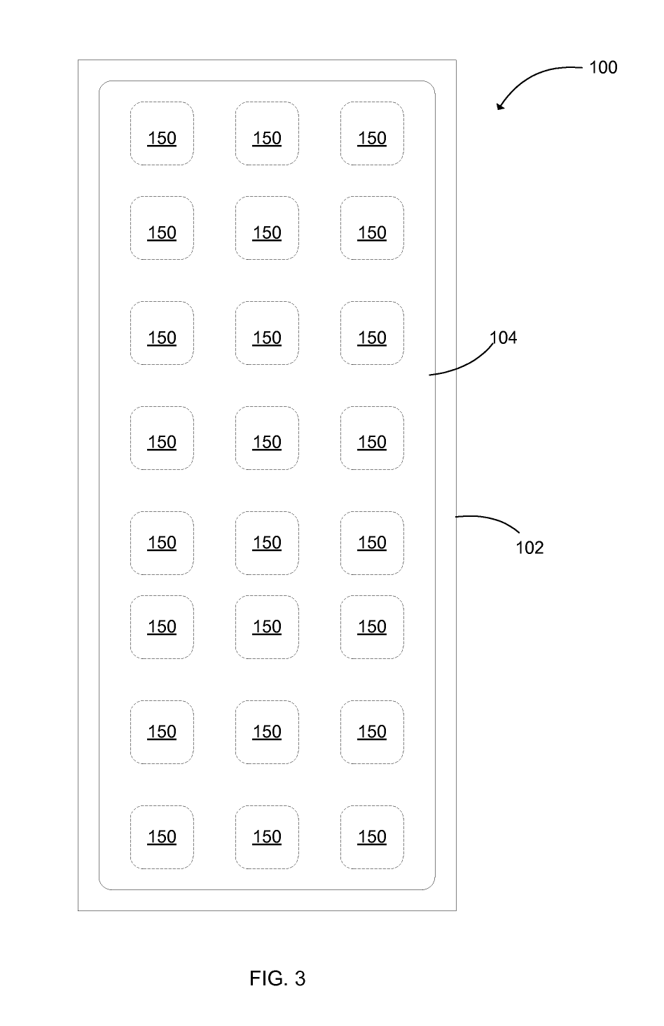

The hydrophobic barrier 104 is formed on the upper surface 110 of the substrate 102. Although the hydrophobic barrier 104 is illustrated in the drawings as having a discernible thickness for clarity of the description, it should be appreciated that in the illustrative embodiment the hydrophobic barrier 104 is formed from a layer of chemistry and, as such, may have a minimal thickness in practice. The hydrophobic barrier 104 is attached to the top surface 108 of the substrate 102 and has a top surface 114, which is contacted by the liquid cover slip 106 when the liquid cover slip 106 is deposited or otherwise positioned thereon. As shown in FIGS. 2 and 3, the hydrophobic barrier 104 defines a plurality of wells 150, each of which includes a bottom wall defined by the upper surface of the substrate 102. A separate microarray (not shown) may be located in each of the wells 150. The hydrophobic barrier 104 may be formed from any material (or chemical modification of the substrate 102) capable of laterally confining a liquid sample in the wells 150 (i.e., restricting the flow of the sample from one well 150 to a nearby well 150). In one particular embodiment, the hydrophobic barrier is formed from trityl-T amidite synthesized onto the substrate 102, but may be formed from other materials in other embodiments.

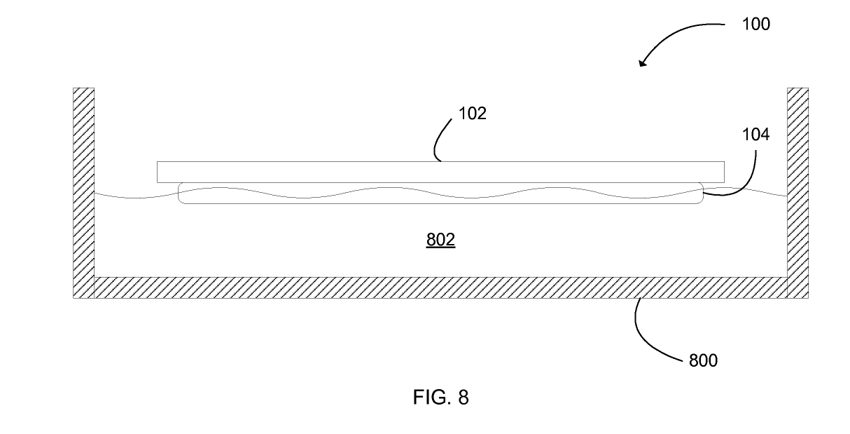

As discussed in more detail below in regard to FIG. 8, the hydrophobic barrier 104 may be fabricated during the synthesis of the plurality of microarrays formed on the substrate 102. That is, the hydrophobic barrier 104 may be formed to surround each microarray formed on the substrate 102. The particular dimensions of the hydrophobic barrier 104 may vary based on the number and size of the individual microarrays, the volume of test sample to be used, the size of the substrate 102, and other considerations. It should be appreciated that the relative dimensions of the structures of the multiplexed array illustrated in the figures are not to scale and may vary across embodiments based on the aforementioned considerations.

The hydrophobic barrier 104 may be formed to define any number of wells 150. For example, as illustrated in FIG. 3, the hydrophobic barrier 104 and the substrate 102 may cooperate to define twenty-four individual wells 150. As discussed above, each of the wells 150 may include a corresponding microarray such that a plurality of different experiments using multiple, different samples may be performed with a single multiplexed array 100. Although the illustrative multiplexed array 100 includes twenty-four wells 150, it should be appreciated that the hydrophobic barrier 104 may include more or less wells 150 in other embodiments. For example, in some embodiments, the multiplexed array 100 may include at least twelve wells 150, at least thirty-six wells 150, at least ninety-six wells 150, or more. Additionally, although the wells 150 are illustrated as being formed in a generally matrix configuration, the wells 150 may be formed in various configurations relative to each other in other embodiments. Additionally, the general shape of the wells 150 may vary in other embodiments based on, for example, the shape and size of the individual microarray located therein.

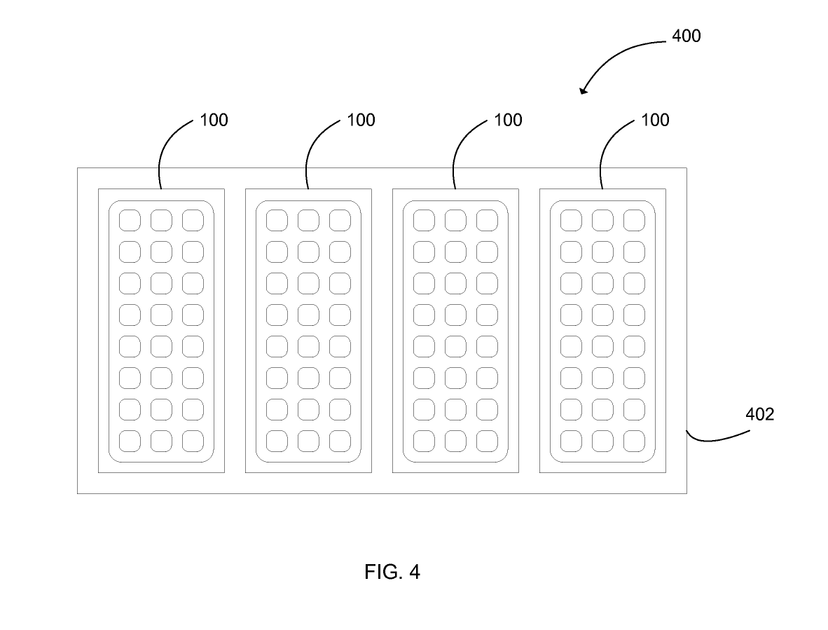

In some embodiments, multiple multiplexed arrays 100 may be combined to form a larger multiplexed array 400 as shown in FIG. 4. In the illustrative embodiment, four individual multiplexed arrays 100, each having twenty-four wells 150 and associated microarrays, are used to form a multiplexed array 400 having ninety-six wells 150 and associated microarrays. In other embodiments, more or less multiplexed arrays 100, each having more or less wells 150, may be used to form the larger multiplexed array 400. The larger multiplexed array 400 may be formed by placing the individual multiplexed arrays 100 in a slide holder 402. The slide holder 402 may be formed from any suitable material capable of holding the multiplexed arrays 100. In one particular embodiment, the slide holder 402 is formed from an aluminum material but may be formed from other materials in other embodiments. In one particular embodiment, the slide holder 402 is embodied as a titration plate holder. It should be appreciated that in such embodiments the multiplexed array 400 may be used with machines and devices typically used with titration plates.

As discussed above, a microarray may be formed on the upper substrate 102 within each well 150. As discussed below in regard to FIG. 8, the microarray may be formed prior to, subsequent to, or contemporaneously with the formation of the hydrophobic barrier 104. The microarrays included in the multiplexed array 100 may be embodied as any type of microarray used for various testing. For example, in one particular embodiment, the microarrays are embodied as deoxyribonucleic acid (DNA) microarrays, which may be used in, for example, gene expression and discovery, mutation detection, allelic and evolutionary sequence comparison, genome mapping, and other research experiments and analysis. In such embodiments, the microarrays are formed from the DNA oligonucleotides attached to the substrate 102. The DNA oligonucleotide “spots” form probes on the substrate 102, which are used in a hybridization process to investigate samples of interest.

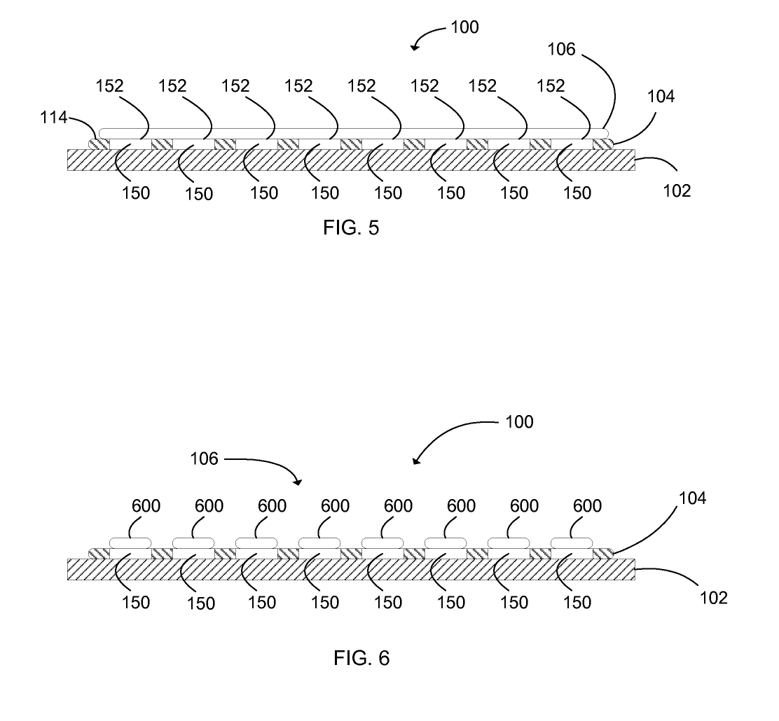

As shown in FIG. 5, each of the wells 150 includes an open end 152 defined in the upper surface 114 of the hydrophobic barrier 104. Without some form of covering over the open ends 152, any sample deposited in the wells 150 is susceptible to evaporation during the hybridization period. As such, the liquid cover slip 106 is deposited or otherwise positioned on the upper surface 114 of the hydrophobic barrier 104 such that the liquid cover slip 106 covers each of the open ends 152 of the wells 150. Due to the size of the wells 150, the viscosity of the liquid cover slip 106, and capillary action, the liquid cover slip 106 may or may not partially or completely fill the individual wells 150. However, the liquid cover slip 106 covers the open end 162 of each well 150 to pneumatically seal the wells 150 from the surrounding open environment. As such, because the wells 150 are pneumatically sealed by the liquid cover slip 106, evaporation of the sample deposited in each well during hybridization is substantially reduced or otherwise eliminated.

The liquid cover slip 106 may be formed from any liquid suitable for pneumatically sealing the wells 150 without adversely affecting or interacting with the microarrays or samples located in the wells 150. In one particular embodiment, the liquid cover slip 106 is embodied as a mineral oil cover slip but other liquids may be used in other embodiments. The liquid cover slip 106 may be deposited and subsequently removed from the upper surface 114 of the hydrophobic barrier 104 using any suitable procedure and/or tool. For example, the liquid cover slip 106 may be deposited and removed using a pipette or similar tool. It should be appreciated that the liquid cover slip 106 is not permanent and may be removed subsequent to hybridization. Additionally, because the liquid cover slip 106 is embodied as a liquid, the sample contained in the wells 150 may be mixed, or otherwise interacted with, without removal of the cover slip 106 in some embodiments. For example, a tool, a jet of air, or other device may be applied to the cover slip 106 to interact with the sample and/or microarray deposited in the individual wells 150. Additionally, it should be appreciated that the application and removal of the liquid cover slip 106 may be automated in some embodiments using, for example, a pipette robot. Additionally, in some embodiments, the application of the samples into the individual wells 150 may be automated in a similar manner.

In some embodiments, as illustrated in FIG. 6, the liquid cover slip 106 may be embodied as a plurality of liquid cover slips 600. In such embodiments, each individual liquid cover slip 600 covers one or more wells 150 to pneumatically seal the open end 152 of each well 150. Additionally, in such embodiments, the liquid cover slips 600 may be separately deposited over each well 150. During the test procedure, the liquid cover slips 600 may or may not interact or otherwise contact each other. The multiple liquid cover slips 600 may be used, for example, in embodiments in which not every well 150 includes an associated microarray.

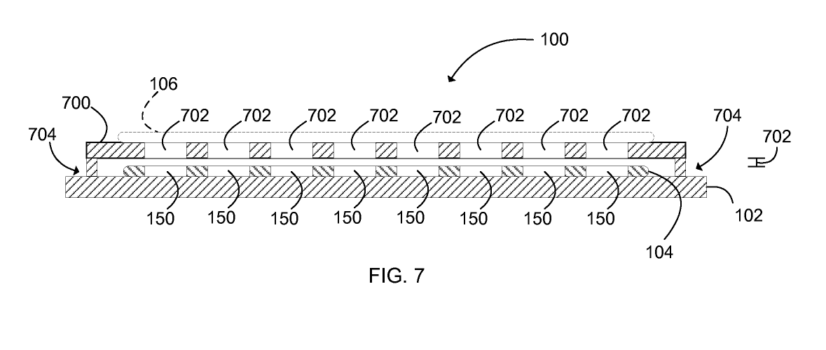

Additionally, in some embodiments, the multiplexed array 100 may further include a physical barrier cover 700 as illustrated in FIG. 7. The physical barrier cover 700 is placed over the hydrophobic barrier 104 but is separated therefrom by a small distance 702 (i.e., the physical barrier cover 700 does not contact the hydrophobic barrier 104). The physical barrier cover 700 may be attached or otherwise secured to the substrate 102 at an outer perimeter 704 of the substrate 102. The physical barrier cover 700 may be attached via use of a suitable adhesive or other mechanisms such as a rubber gasket (not shown) positioned between the physical barrier cover 700 and the substrate 102 to form a pneumatic seal.

The physical barrier cover 700 is a well-forming device and includes a plurality of apertures 706 defined therethrough. The apertures 706 are located such that each aperture 706 is positioned over a corresponding microarray formed on the substrate 102. As such, the apertures 706 provide a visible cue during use of the locations at which the liquid sample should be pipetted or otherwise deposited. Additionally, the apertures 706 may further confine the liquid samples from spreading laterally. In this way, the liquid sample is confined by a combination of the hydrophobic barrier 106 and the physical barrier cover 700. It should be appreciated that because the physical barrier cover 700 does not contact the hydrophobic barrier 106, the ease of aligning the physical barrier cover 700 is improved because precise alignment may not be required unlike those embodiments wherein the cover 700 directly contacts the barrier 106. The lack of contact between the physical barrier cover 700 and the hydrophobic barrier 106 also may allow the microarray 100, or parts thereof, to be reusable (e.g., in embodiments wherein a rubber gasket is used to seal the physical barrier cover 700 and the substrate 102.). Additionally, in some embodiments, a liquid cover slip 106 or other sealing mechanism may be applied over the top surface of the physical barrier cover 700 to form a pneumatic seal that reduces or otherwise prevents evaporation of the liquid sample during hybridization.

Referring now to FIG. 8, in some embodiments, the liquid cover slip 106 may be embodied as a liquid cover slip 802, which is located in a container 800. In such embodiments, the substrate 102 and hydrophobic barrier 104 are inverted and inserted into the liquid cover slip 802. That is, the hydrophobic barrier 104 is positioned completely or partially in the liquid cover slip 802. To do so, a handle or other attached device (not shown) may be secured to the substrate 102 to facilitate positioning of the substrate 102 and the hydrophobic barrier 104 in the liquid cover slip 802. Similar to the liquid cover slip 106, the liquid cover slip 802 may be formed from any liquid suitable capable of pneumatically sealing the wells 150 without adversely affecting or interacting with the microarrays or samples located in the wells 150. In one particular embodiment, the liquid cover slip 802 is embodied as a mineral oil cover slip but other liquids may be used in other embodiments.

The container 800 may be embodied as any type of container formed from any material suitable for containing the liquid cover slip 802. In some embodiments, the container 800 may include a heating source (not shown) configured to heat the liquid cover slip 802 contained therein. For example, in one embodiment, the liquid cover slip 802 is maintained at a temperature between about 40 degrees Celsius to about 60 degrees Celsius during hybridization. In one particular embodiment, the liquid cover slip 802 is heated and maintained at a temperature of about 42 degrees Celsius. Alternatively, rather than maintaining the temperature of the liquid cover slip 802 at a substantially constant temperature, the temperature of the liquid cover slip 802 may be cycled through varying degrees during hybridization in some embodiments.

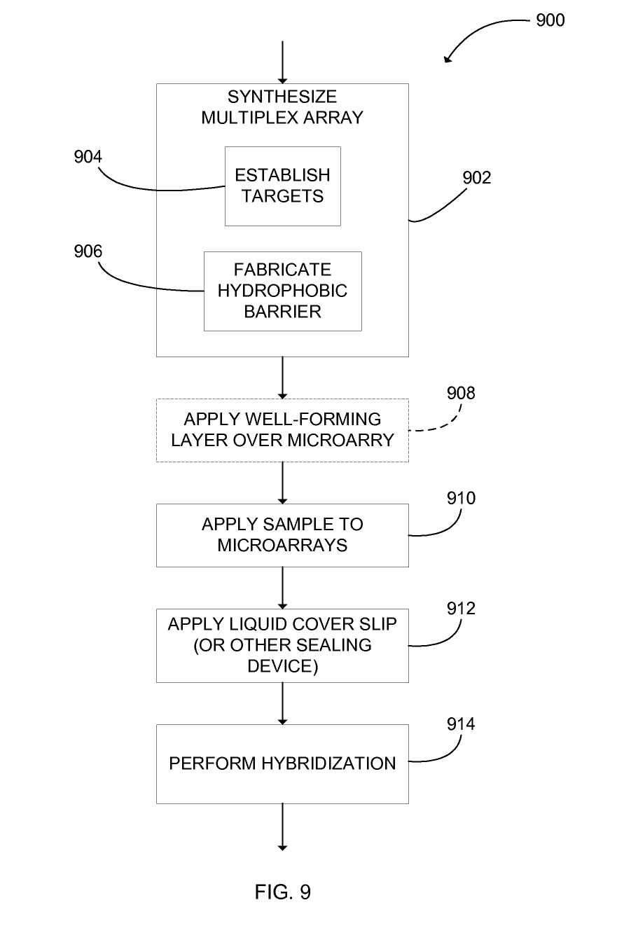

Referring now to FIG. 9, a method 900 for fabricating a multiplexed array 100 begins with block 902 in which the multiplexed array 100 is synthesized. For example, in block 904, the individual microarray targets or features are formed on the substrate 102. Subsequently or contemporaneously with the formation of the microarray targets in block 904, the hydrophobic barrier is formed or fabricated in block 906. The individual microarrays and the hydrophobic barrier 104 may be formed using any suitable procedure. For example, in some embodiments, the microarrays are synthesized by the synthesis of a short DNA-based linker sequence over the upper surface 110 of the substrate 102.

In other embodiments, the microarrays and hydrophobic barrier 106 may be formed by coupling a substantially uniform layer of NPPOC (2-(2 nitro phenyl) propoxy carbonyl) protected phosphoramidite across the upper surface 110 of the substrate 102. The individual microarrays may then be synthesized in the desired arrangement. Barrier regions wherein hydrophobic barriers are desired are selectively photo-deprotected, and conventional trityl (Dimethoxytrityl) protected groups or other phosphoramidites bearing hydrophobic groups are coupled to the barrier regions on the substrate 102. The barrier regions are coupled with trityl-protected phosphoramidite under conditions wherein a deblock step is not performed. The result of such formation is a grid of microarrays wherein each microarray is separated from adjacent microarrays by a barrier of hydrophobic group-bearing phosphoramidites.

In some embodiments, a well-forming layer or cover is applied over the microarrays in block 908. For example, in some embodiments, the physical barrier cover 700 may be placed over the microarrays and attached to the substrate 102. As discussed above, the physical barrier cover 700 may be attached to the substrate 102 via use of a suitable adhesive, rubber gasket, or other mechanisms. Additionally, the apertures 706 of the physical barrier cover provide a visible cue of the locations at which the liquid sample should be pipetted. Further, the apertures 706 may cooperate with the hydrophobic barrier 106 to confine the liquid samples from spreading laterally as discussed above.

In block 910, the liquid sample is applied to the microarrays. To do so, the sample of interest is deposited into each well 150. As discussed above, because of the use of they hydrophobic barrier 106, different samples may be deposited in different wells such that experiments using various samples may be performed concurrently. The hydrophobic barrier 106 confines the samples to each individual well 150 and reduces the likelihood of cross-contamination of samples. In embodiments in which the physical barrier cover 700 is used, the liquid sample is deposited via the apertures 706. Additionally, as discussed above, the physical barrier cover 700 and the hydrophobic barrier 106 cooperate to confine the liquid sample to each individual well 150.

Subsequently, in block 912, the liquid cover slip 106 is applied to the upper surface 114 of the hydrophobic barrier 104. As discussed above, the application of the liquid cover slip 106 may be performed manually or via use of automated means such as a pipette robot. Additionally, in some embodiments such as those illustrated in FIG. 1-7, the liquid cover slip 106 may deposited or otherwise positioned on the upper surface 114 of the hydrophobic barrier 106. However, in the embodiment of FIG. 8, the liquid cover slip 106 is applied by inserting a portion of the hydrophobic barrier (and substrate 102 in some embodiments) into a bath of the liquid cover slip 106, 802 located in the container 800. In embodiments wherein the liquid cover slip 106 is embodied as a plurality of liquid cover slips 600 (see FIG. 6), each one of the individual cover slips 600 may be deposited in block 912. To do so, each individual liquid cover slip 600 may be separately deposited so as to cover one or more wells 150. As discussed above, the liquid cover slip 106, 600, 802 is applied to the hydrophobic barrier so as to pneumatically seal the open end 152 of each well 150 to reduce or otherwise eliminate the evaporation of the sample located therein.

In some embodiments, other sealing devices or mechanisms may be used in place of or in addition to the liquid cover slip 600. For example, in some embodiments, a sealing foil/film or an air-tight cover may be applied over the hydrophobic barrier 106 (or over the physical barrier cover 700 in those embodiments in which the cover 700 is used) to pneumatically seal the open end 152 of each well 150 to reduce or otherwise eliminate the evaporation of the sample located therein.

Subsequently, in block 914, the hybridization process is performed using the multiplexed array 100. The hybridization is a process in which the multiplexed array 100 is allowed to incubate at a set temperature for a determined amount of time. Additionally, in some embodiments such as the embodiment illustrated in FIG. 8, the liquid cover slip 106 may be heated during the hybridization process of block 914. In such embodiments, as discussed above, the liquid cover slip 106, 802 may be maintained at a temperature between about 40 degrees Celsius to about 60 degrees Celsius during hybridization. Alternatively, rather than maintaining the temperature of the liquid cover slip 106, 802 at a substantially constant temperature, the temperature of the liquid cover slip 106, 802 may be cycled through varying degrees during hybridization in some embodiments.

It should be appreciated that use of the multiplexed array 100 may be automated in some embodiments. For example, as discussed above, the application of the samples into the wells 150 may be performed using a pipette robot. Similarly, the application and removal of the liquid cover slip 106, 600, 802 may be performed using a pipette robot. As such, it should be appreciated that the speed at which the experiments are completed may be increased via use of such automated procedures.

There is a plurality of advantages of the present disclosure arising from the various features of the apparatuses, circuits, and methods described herein. It will be noted that alternative embodiments of the apparatuses, circuits, and methods of the present disclosure may not include all of the features described yet still benefit from at least some of the advantages of such features. Those of ordinary skill in the art may readily devise their own implementations of the apparatuses, circuits, and methods that incorporate one or more of the features of the present disclosure and fall within the spirit and scope of the present invention as defined by the appended claims.

1. A multiplexed array comprising:
a substrate;
a hydrophobic barrier formed on the substrate, the hydrophobic barrier defining a plurality of wells, each of the plurality of wells including an opening for access to an interior of the well;
a microarray positioned in each of the plurality of wells and attached to the substrate;
a liquid sample deposited in at least one of the plurality of wells; and
a liquid cover slip positioned in contact with the hydrophobic barrier and over the opening of each well to removably seal the plurality of wells.

2. The multiplexed array of claim 1, wherein the hydrophobic barrier is formed from trityl-T amidite.

3. The multiplexed array of claim 1, wherein the hydrophobic barrier defines at least twenty-four wells.

4. The multiplexed array of claim 3, wherein the hydrophobic barrier defines at least ninety-six wells.

5. The multiplexed array of claim 1, wherein the microarray comprises a deoxyribonucleic acid (DNA) microarray.

6. The multiplexed array of claim 1, wherein the liquid cover slip comprises a mineral oil cover slip.

7. The multiplexed array of claim 1, wherein the liquid cover slip comprises a plurality of liquid cover slips, each one of the plurality of liquid cover slips being positioned over at least one opening of the plurality of wells.

8. The multiplexed array of claim 1, wherein the liquid cover slip comprises a quantity of liquid positioned in a container and a portion of the hydrophobic barrier is positioned in the liquid.

9. The multiplexed array of claim 1, further comprising:
a container, wherein the liquid cover slip is positioned in the container.

10. The multiplexed array of claim 1, wherein the substrate comprises a glass substrate.

11. The multiplexed array of claim 1, wherein the substrate comprises a silicon substrate.

12. A multiplexed array comprising:
a hydrophobic barrier formed on a substrate, the hydrophobic barrier and substrate cooperating to define a plurality of wells, each well including (i) an opening defined in an upper surface of the hydrophobic barrier and (ii) a microarray positioned therein;
a well-forming cover positioned over the hydrophobic barrier, the hydrophobic barrier and the well-forming cover cooperating to laterally contain liquid samples in each one of the plurality of wells when the liquid samples are deposited therein; and
means for removably sealing each well of the plurality of wells.

13. The multiplexed array of claim 12, wherein the means for removably sealing each well comprises a liquid cover slip.

13. The multiplexed array of claim 12, wherein the hydrophobic barrier is formed from trityl-T amidite.

14. The multiplexed array of claim 12, wherein the hydrophobic barrier and substrate define at least twenty-four wells.

15. The multiplexed array of claim 14, wherein the hydrophobic barrier and substrate define at least ninety-six wells.

16. The multiplexed array of claim 12, wherein each well of the plurality of wells includes a deoxyribonucleic acid (DNA) microarray positioned therein.

17. The multiplexed array of claim 12, wherein the liquid cover slip comprises a mineral oil cover slip.

18. The multiplexed array of claim 12, wherein the liquid cover slip comprises a plurality of liquid cover slips, each one of the plurality of liquid cover slips being positioned over at least one opening of the plurality of wells.

19. A method for fabricating a multiplexed array, the method comprising:
synthesizing a plurality of plurality of probes on a common substrate to form a plurality of microarrays;
forming a hydrophobic barrier on the common substrate, the hydrophobic barrier surrounding each microarray to form a plurality of wells, and
positioning a liquid cover slip on the hydrophobic barrier such that the liquid cover slip covers each of the plurality of wells.

20. The method of claim 19, wherein positioning the liquid cover slip comprises inserting at least a portion of the hydrophobic barrier into a bath of mineral oil.
